(19) United States
(12) Patent Application Publication
(10) Pub. No.: US 2010/0156895 A1
(43) Pub. Date: Jun. 24, 2010

(54) Processing Pre-recorded Hogel Data

(75) Inventors: Wesley A. Holler, Austin, TX (US); Gary Anthony McElroy, JR., Austin, TX (US); Michael E. Weiblen, Black Hawk, CO (US); Thomas Lawrence Burnett, III, Austin, TX (US); Mark E. Lucente, Austin, TX (US)

Correspondence Address: Georgios A. Georgakis;Chowdhury & Georgakis, PC, PO BOX 90277, AUSTIN, TX, 78709-0277, US

(73) Assignee: ZEBRA IMAGING, INC., Austin, TX (US)

(21) Appl. No.: 12/606,137

(22) Filed: Oct. 26, 2009

Related U.S. Application Data
(63) Continuation of application No. 12/606,099, filed on Oct. 26, 2009.
Application No. 12/606,099 is a continuation of application No. 12/546,049, filed on Aug. 24, 2009.
(60) Provisional application No. 61/108,549, filed on Oct. 26, 2008.

(51) Int. Cl. G06T 15/00; G06F 15/16

(52) U.S. Cl. 345/419; 345/502

(57) ABSTRACT

Methods and systems for rendering hogels, including causing one or more nodes to each load a subset of a hogel data set into a buffer, the one or more nodes being configured to each store the corresponding subset of the hogel data set, distributing a next hogel data set command to the one or more nodes, causing the buffer to be processed in response to the next hogel data set command, and issuing a hogel data set complete command in response to determining that the one or more nodes each return a hogel data subset complete command.

### I. PRIORITY CLAIM

This application is a continuation of and claims priority from:
U.S. patent application Ser. No. 12,606,099, filed 26 Oct. 2009, titled “Rendering 3D Data to Hogel Data” and naming Michael E. Weiblen, et. al, as inventor(s), which in-turns claims priority from
U.S. patent application Ser. No. 12,546,049, filed 24 Aug. 2009, titled “Converting 3D Data to Hogel Data” and naming Wesley A. Holler, et. al, as inventor(s), which in-turns claims priority from
U.S. Provisional Application No. 61/108,549, filed 26 Oct. 2008, titled “Systems and Methods for Converting 3D Data to Hogel Data” and naming Michael E. Weiblen, et. al, as inventor(s).

The above-referenced patents and/or patent applications are hereby incorporated by reference herein in their entirety.

### II. GOVERNMENT CONTRACT STATEMENT

The U.S. Government has a paid-up license in this invention and the right in limited circumstances to require the patent owner to license others on reasonable terms as provided for by the terms of contract No. W91CRB-09-C-0031 awarded by RDECOM.

### III. BACKGROUND

The invention relates generally to the field of processing pre-recorded hogel data.

### IV. SUMMARY

In one respect, disclosed is a method for processing stored hogel data, the method comprising causing one or more nodes to each load a subset of a hogel data set into a buffer, the one or more nodes being configured to each store the corresponding subset of the hogel data set, distributing a next hogel data set command to the one or more nodes, causing the buffer to be processed in response to the next hogel data set command, and issuing a hogel data set complete command in response to determining that the one or more nodes each return a hogel data subset complete command.

In another respect, disclosed is a system for rendering hogels, the system comprising one or more processors, and one or more memory units coupled to the processor, the system being configured to cause one or more nodes to each load a subset of a hogel data set into a buffer, the one or more nodes being configured to each store the corresponding subset of the hogel data set, distribute a next hogel data set command to the one or more nodes, cause the buffer to be processed in response to the next hogel data set command, and issue a hogel data set complete command in response to determining that the one or more nodes each return a hogel data subset complete command.

In yet another respect, disclosed is a computer program product stored on a computer operable medium, the computer program product comprising software code being effective to cause one or more nodes to each load a subset of a hogel data set into a buffer, the one or more nodes being configured to each store the corresponding subset of the hogel data set, distribute a next hogel data set command to the one or more nodes, cause the buffer to be processed in response to the next hogel data set command, and issue a hogel data set complete command in response to determining that the one or more nodes each return a hogel data subset complete command.

Numerous additional embodiments are also possible. In one or more various aspects, related articles, systems, and devices include but are not limited to circuitry, programming, electro-mechanical devices, or optical devices for effecting the herein referenced method aspects; the circuitry, programming, electro-mechanical devices, or optical devices can be virtually any combination of hardware, software, and firmware configured to effect the herein referenced method aspects depending upon the design choices of the system designer skilled in the art.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

In addition to the foregoing, various other method, device, and system aspects are set forth and described in the teachings such as the text (e.g., claims or detailed description) or drawings of the present disclosure.

### V. BRIEF DESCRIPTION OF THE DRAWINGS

Other aspects and advantages of the invention may become apparent upon reading the detailed description and upon reference to the accompanying drawings.

FIG. 1 is a block diagram illustrating a system for processing prerecorded hogel data, in accordance with some embodiments.

FIG. 2 is a block diagram illustrating an alternative system for processing prerecorded hogel data, in accordance with some embodiments.

FIG. 3 is a block diagram illustrating a system for generating and storing, distributively, hogel data, in accordance with some embodiments.

FIG. 4 is a flow diagram illustrating a method for processing prerecorded hogel data, in accordance with some embodiments.

FIG. 5 is a flow diagram illustrating a method for displaying prerecorded hogel data, in accordance with some embodiments.

FIG. 6 is a flow diagram illustrating an alternative method for displaying prerecorded hogel data, in accordance with some embodiments.

Brief description for the additional figures is provided in the detailed description section.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### VI. DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupled,” or “coupleable” are intended to mean either an indirect or direct electrical or wireless connection. Thus, if a first device couples to a second device, that connection may be through a direct electrical, optical, wireless connection, etc. or through an indirect electrical, optical, wireless connection, etc. by means of other devices and connections.

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

In some embodiments, systems and methods are disclosed for accessing and processing distributively stored hogel data. In some embodiments, the synchronized processing of the hogel data may be desired. Therefore, synchronizing mechanisms may be implemented to ensure the synchronized or near-synchronized processing of the distributively stored hogel data.

In some embodiments, the processing may be performed on a group of hogel data and may be performed a subset at a time. For example, in embodiments where the hogel data may represent 3D movie data, processing the hogel data, in this embodiment, may involve the displaying of the data on a hogel light modulator. In this embodiment, the group of hogel data may refer to hogel data representing the 3D movie, and processing/displaying, in such embodiments, may be performed one frame (set) at a time. In such embodiments, synchronization may be implemented to ensure that each frame is processed (displayed) synchronously or near-synchronously.

In some embodiments, the processing of a group of hogel data may be initiated and processing flow controlled by a processing controller. The controller may be configured, for example, to communicate to the one or more nodes (in addition to other modules or devices) information about which group of hogel data is to be processed, where in the data to begin the processing (such as at which set to begin the processing), when to stop the processing, how fast to process the data, what type of processing to apply, etc.

In embodiments where the hogel data represents 3D movie data, the processing controller may be a specialized 3D movie player, for example. The 3D movie player may be configured to provide an interface from which a user may select a movie to play, start and stop the movie, fast forward and rewind the movie, play the movie in slow motion, etc.

In embodiments where the hogel data represents a 3D movie, the 3D movie data may be stored by distributing respective subsets of each frame of the hogel data to corresponding one or more of the nodes. Movie 3D hogel data may be then retrieved and displayed synchronously (or substantially synchronously) a frame at a time on a hogel light modulator, for example. In some embodiments, the hogel data frames may be generated in respective portions at the one or more nodes, and subsequently, the respective portions of the hogel data frames may be stored at the corresponding nodes for later retrieval.

In some embodiments, a distribution and synchronization service may be used to implement the synchronized processing of the hogel data one set at a time. In some embodiments, the next set of hogel data to be processed may be loaded from the one or more nodes into a processing buffer. A subset from each set of hogel data may be loaded from a corresponding node. In some embodiments, the processing of the buffer may not be initiated until a command to do so is received from the processing controller.

In some embodiments, the controller may be configured to issue a next frame (set) command to cause the processing of the next frame of hogel data. The command may be received by the distribution and synchronization service and then the command may be copied and distributed to each one of the nodes by the distribution and synchronization service. In response to receiving the next frame command, the nodes may then cause the substantially synchronous processing of the processing buffer. In some embodiments, for example, the processing of the buffer may include substantially synchronously displaying the hogel data in the buffer using a hogel light modulator.

The nodes may then notify the synchronization service that the set of hogel data or processing is complete, and in response to receiving notifications from all the nodes, the synchronization service may then notify the processing controller that the set of hogel data or frame processing is complete. If processing is to continue, the processing controller may then issue another next frame command. It should be noted that, in other embodiments, the synchronization process may be implemented using alternative methods and/or alternative sequences.

The hogel data may be stored at one or more nodes, such that each subset from each set of the hogel data is stored at a corresponding one of the nodes. In some embodiments, each subset of hogel data may be stored at a corresponding node after the subset of the hogel data is generated at the corresponding node.

In embodiments where the subsets or frames of hogel data may be generated as well as stored at the one or more nodes, the distribution and synchronization service may also be configured to receive sets or frames of 3D data/commands and distribute the 3D data to the one or more nodes for rendering and storing, for example. The nodes may be configured to receive various types of 3D data (such as computer-generated 3D data; multi-2D view data; data with multiple independent 2D views that may be used to represent different 2D views from different observation locations; voxel type data; non-image 3D data; data for representing holographic elements; geometric vertex data, such as CAD or architectural models, etc.) and to convert that data to hogel data using the distributed node setup. The one or more nodes may be configured to convert and store, in subsets, the 3D data into hogel data. The hogel data may be stored in subsets and then retrieved in those subsets for later processing such as displaying the hogel data on a hogel light modulator.

For additional discussion on hogels and hogel light modulators, please see U.S. patent application Ser. No. 12/258,438, filed 26 Oct. 2008, entitled “Systems and Methods for Calibrating a Hogel Display” and naming Mark E. Lucente as inventor. The above-referenced patent application is hereby incorporated by reference herein in its entirety.

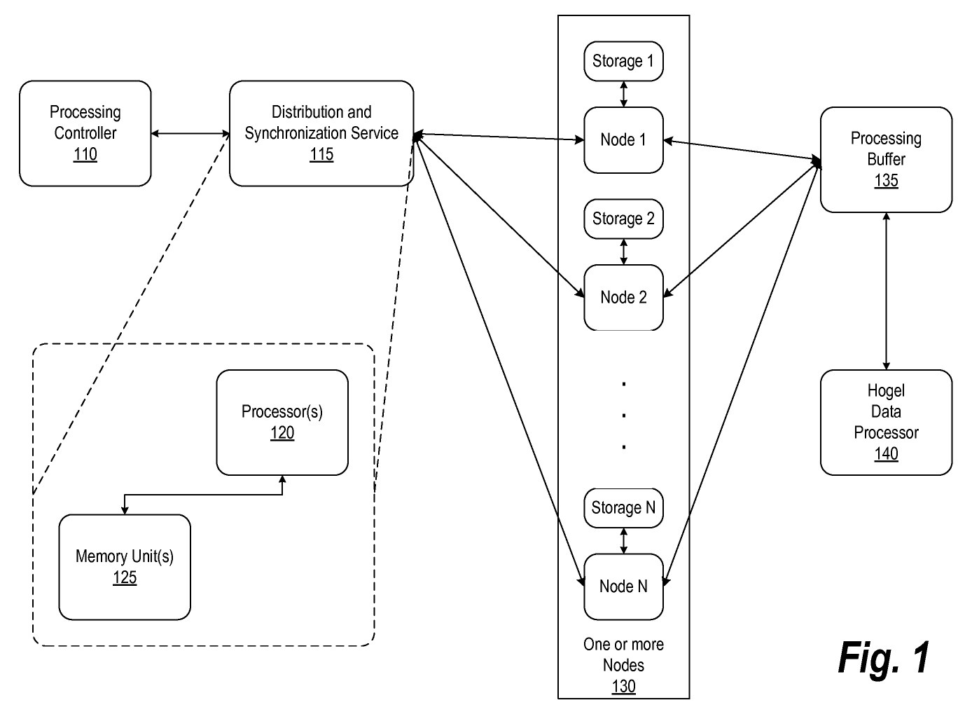

FIG. 1 is a block diagram illustrating a system for processing prerecorded hogel data, in accordance with some embodiments.

One or more nodes 130 (nodes 1 though N) are configured to distributively store sets of hogel data in corresponding one or more storage units 1 though N, a subset of each set in each node, for example. In some embodiments, the sets of hogel data may represent frames of a hogel movie.

In some embodiments, the distributively stored hogel data at one or more nodes 130 is to be retrieved from one or more nodes 130 and loaded into processing buffer 135 in order to be substantially synchronously processed set-by-set using hogel data processor 140, for example. In some embodiments, controller 110 may be configured to control the processing of the hogel data stored in one or more nodes 130. Controller 110 may, for example, identify which group of hogel data to process and may also control the start and finish of the processing, the type of processing, the speed of the processing, etc. It should be noted that processing buffer 135 and hogel data processor 140 may be each implemented using multiple units. For example, a corresponding processing buffer and hogel data processor may be used for each one of nodes 130. In other embodiments, a group of five nodes, for example, may share a single processing buffer and hogel data processor.

Distribution and synchronization service 115 is configured, in some embodiments, to facilitate the communication between controller 110 and the one or more nodes 130. In some embodiments, controller 110 may be implemented using one or more processors 120, which are coupled to one or more memory units 125. Processors 120 may be configured to process instructions that may be stored in memory units 125 in order to implement the functionality of distribution and synchronization service 115.

Distribution and synchronization service 115 is configured to receive commands and responses from controller 110 and to copy and distribute those commands and responses to the one or more nodes. Distribution and synchronization service 115 is also configured to receive and process multiple responses and commands from the one or more nodes 130 and to logically process those responses and commands into a single response or command for controller 110.

In some embodiments, synchronization service 115 may be used to implement the synchronized processing of the hogel data one frame at a time. In some embodiments, the next set of hogel data to be processed may be loaded from one or more nodes 130 into processing buffer 135. In some embodiments, the processing buffer may not be processed until a command to do so is received from controller 110.

In some embodiments, controller 110 may be configured to issue a next frame command to cause the processing of the next set of hogel data. The command may be received by synchronization service 115 and then the command may be copied and distributed to each one of the nodes by synchronization service 115. In response to receiving the next frame command, nodes 130 may then cause the substantially synchronous processing of the processing buffer. In some embodiments, for example, the processing of the buffer may involve substantially synchronously displaying the buffer using a hogel light modulator.

Nodes 130 may then notify synchronization service 115 that the subset of hogel data or frame processing is complete, and in response to receiving notifications from all the nodes, synchronization service 115 may then notify processing controller 110 that the subset of hogel data or frame processing is complete. If processing is to continue, processing controller 110 may then issue another next frame command.

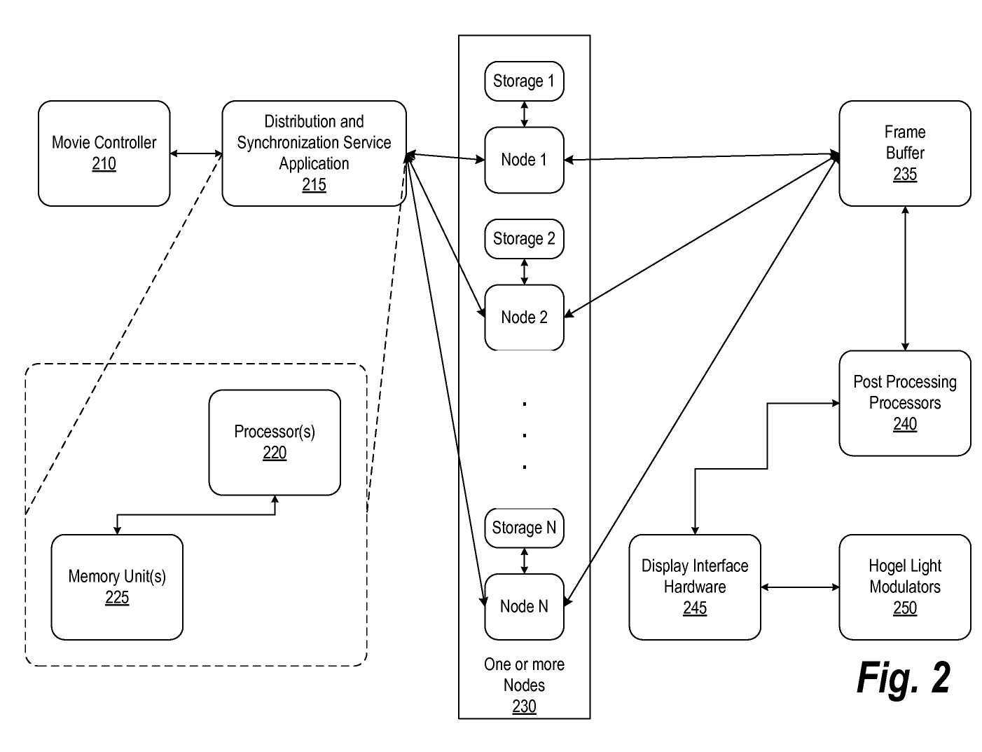

FIG. 2 is a block diagram illustrating an alternative system for processing prerecorded hogel data, in accordance with some embodiments.

One or more nodes 230 (nodes 1 though N) are configured to distributively store subsets of frames of hogel data movies in corresponding one or more storage units 1 though N. In some embodiments, the distributively stored hogel data at the one or more nodes 230 is to be retrieved from the one or more nodes 230 and loaded into frame buffer 235 in order to be substantially synchronously processed, prepared, and/or displayed frame-by-frame on a hogel light modulator.

In some embodiments, movie controller 210 may be configured to control the process of the displaying the hogel data movie stored in one or more nodes 230. Movie controller 210 may, for example, identify the movie to be played and also control the start and finish of the movie, the speed with which to play the movie, the pausing of the movie, etc.

Distribution and synchronization service 215 is configured to facilitate the communication between movie controller 210 and the one or more nodes 230, in addition to other functionality. In some embodiments, movie controller 210 may be implemented using one or more processors 220, which are coupled to one or more memory units 225. Processors 220 may be configured to process instructions that may be stored in memory units 225 in order to implement the functionality of distribution and synchronization service 215.

Distribution and synchronization service 215 may be configured to receive commands and responses from movie controller 210 and to copy and distribute those commands and responses to the one or more nodes. Distribution and synchronization service 215 may also be configured to receive and process multiple responses and commands from the one or more nodes 230 and to logically process those responses and commands into a single response or command for movie controller 210.

In some embodiments, synchronization service 215 may be used to implement the synchronized displaying of the hogel movie a frame at a time. In some embodiments, the next frame of hogel data to be displayed may be loaded from one or more nodes 230 into frame buffer 235. A portion of the frame may be loaded from each of the one or more nodes 230.

In some embodiments, movie controller 210 may be configured to issue a next frame command to cause the processing of the next set of hogel data. The command may be received by synchronization service 215 and then the command may be copied and distributed to each one of the nodes by synchronization service 215. In response to receiving the next frame command, nodes 230 may then cause the substantially synchronous processing of the processing buffer. In some embodiments, for example, the processing of the buffer may involve substantially synchronously displaying the buffer using a hogel light modulator.

Nodes 230 may then notify synchronization service 215 that the subset of hogel data or frame processing is complete, and in response to receiving notifications from all the nodes, synchronization service 215 may then notify processing controller 210 that the current frame processing is complete. If processing is to continue, processing controller 210 may then issue another next frame command.

In some embodiments, additional optional post processing may be applied to the hogel data using post processing processors 240. Post processing processors 240 may be configured, for example, to calibrate the hogel data. Other post processing may also be applied to the hogel data. The frame of hogel data may then be displayed on hogel light modulator(s) 250 with the help of display interface hardware 245.

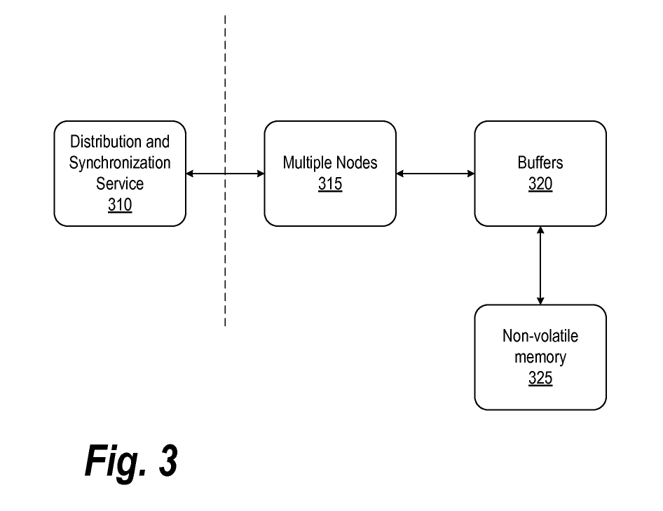

FIG. 3 is a block diagram illustrating a system for generating and storing, distributively, hogel data, in accordance with some embodiments.

In some embodiments, distribution and synchronization service 310 may also be configured to receive 3D data/commands and distribute the data/commands to one or more nodes such as multiple rendering nodes 315. Multiple nodes 315 may be configured to convert/render the 3D data/commands into hogel data. In some embodiments, each of the nodes may be configured to be responsible for the conversion/rendering of a portion of each frame of the hogel data.

In addition, distribution and synchronization service 310 may be configured to control and synchronize the conversion/rendering process. In some embodiments, the 3D data/commands may be forwarded to rendering nodes 315 for processing. In alternative embodiments, only a subset of the 3D data/commands may be sent to each rendering node. In some embodiments, a single graphics processing unit may be used per node. In alternative embodiments, one or more GPUs may be used at each node to implement the conversion/rendering process. In yet alternative embodiments, one or more rendering nodes may share one GPU.

After a group of nodes finishes rendering a portion of the hogel data, the hogel data may be stored in buffers 320. In some embodiments, a separate buffer or buffers may be used for each node. In some embodiments, when a rendering node has finished rendering, the rendering node informs distribution and synchronization service 310 of the rendering finish. The distribution and synchronization service waits until all the rendering nodes have reported that the nodes have completed the rendering and then sends a synchronized command to the rendering nodes to send the hogel data towards non-volatile memory 325.

In some embodiments, in addition or instead of additional processing (such as the displaying of the hogel data using a hogel light modulator), the hogel data may be stored in non-volatile memory 325 for playing back at a later time. In some embodiments, a separate non-volatile memory unit or units may be used for each node. In some embodiments, the hogel data may be stored frame-by-frame portions in the non-volatile units. The hogel data may be stored in separate files or in one single file. For example, each 2D hogel view may be arranged on a grid to form one large 2D image frame.

In some embodiments, the hogel movies may be encoded using available 2D video codecs, such as avi codecs, mpeg codecs, etc. In other embodiments, specialized 3D codecs may be used to take advantage, for example, of redundant information across multiple hogels in the same frame when storing the same data.

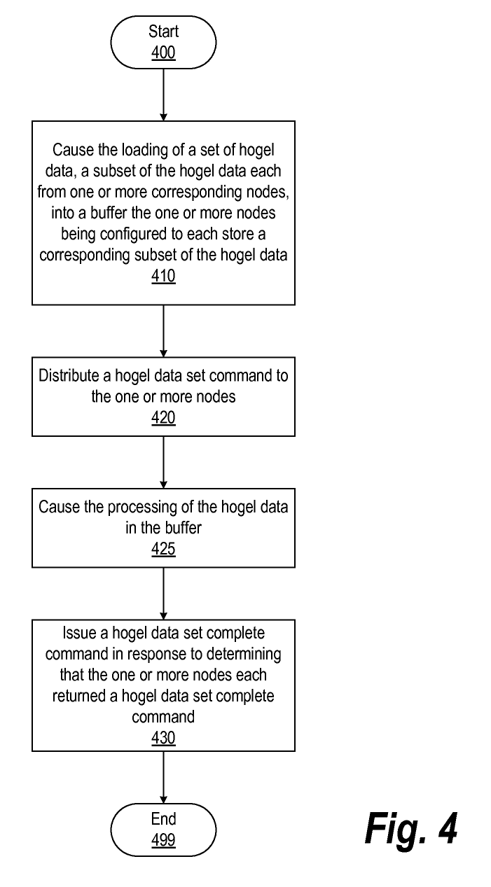

FIG. 4 is a flow diagram illustrating a method for processing prerecorded hogel data, in accordance with some embodiments. It should be noted that, in some embodiments, the methods described here may be performed by the system described in FIG. 1 though FIG. 3.

Processing begins at 400 where, at block 410, the loading of a set of hogel data from one or more nodes into a buffer is caused. In some embodiments, the one or more nodes is configured to each store a corresponding subset of the set of hogel data.

At block 415, a hogel data frame command is received, and at block 420, the hogel data frame command is copied and distributed to the one or more nodes.

At block 425, the processing of the hogel data in the buffer is caused, and at block 430, a hogel data frame complete command is issued in response to determining that the one or more nodes has each returned a hogel data frame complete command.

Processing subsequently ends at 499.

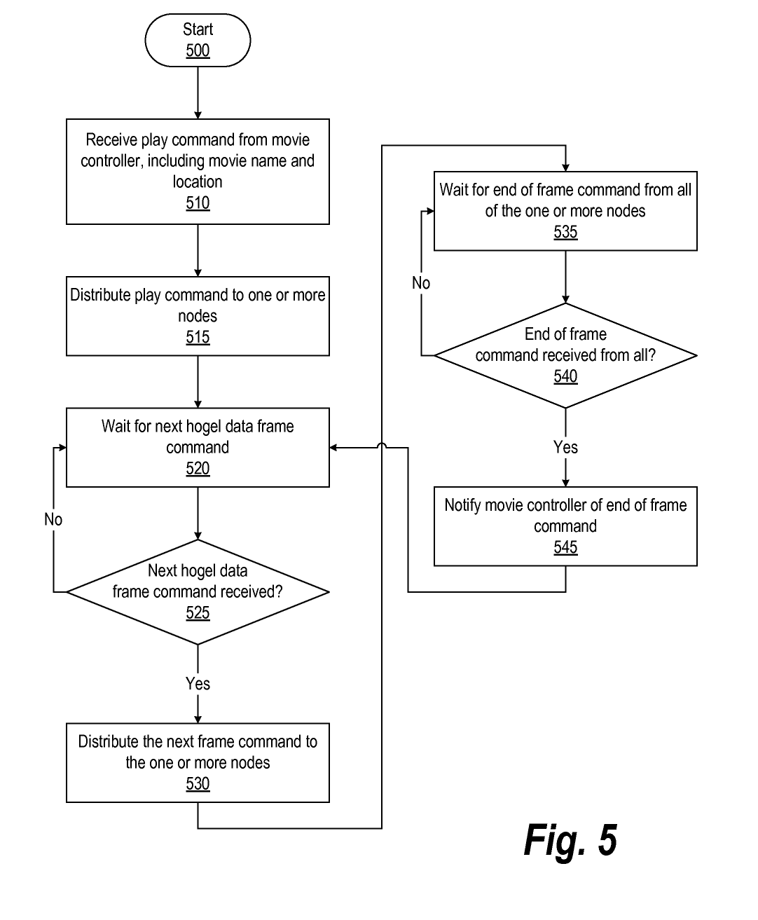

FIG. 5 is a flow diagram illustrating a method for displaying prerecorded hogel data, in accordance with some embodiments. It should be noted that, in some embodiments, the methods described here may be performed by the system described in FIG. 1 though FIG. 3. In some embodiments, the methods described here may be performed by a distribution and synchronization device.

Processing begins at 500 where, at block 510, a play command for a stored hogel movie is received from a movie controller. In some embodiments, an initial play command may also include information about the movie's name and/or location in order for the correct hogel movie to be accessed. The movie controller may be a device or process configured to initialize and control the display of the hogel movie on a hogel light modulator, for example.

At block 515, the play command is distributed to one or more nodes. In some embodiments, the movie data frames may be distributively stored at the one or more nodes. For example, each frame of the hogel movie may be divided into portions and each portion may be stored at a corresponding node. In some embodiments, the movie portions may be generated and accordingly stored at each node frame-by-frame.

At block 520, the system waits for the next hogel data frame command. At decision 525, a determination is made as to whether the next hogel data frame command has been received. If the command has not yet been received, decision 525 branches to the “no” branch where processing returns to block 520. At block 520, the system continues to wait for the next hogel data frame command.

On the other hand, if the next hogel data frame command is received, decision 525 branches to the “yes” branch where, at block 530, the next frame command is distributed to the one or more nodes. In some embodiments, the one or more nodes may have already loaded corresponding portions of the hogel data frame into a buffer while waiting for the next frame command. In response to receiving the distributed next frame command, the one or more nodes cause the processing and/or the displaying of the hogel data frame.

At block 535, the system waits for the one or more nodes to each issue an end of frame command indicating that the current buffer has been processed. A determination is then made as to whether an end of frame command has been received from all the nodes at decision 540. If it is determined that not all the nodes have issued the end of frame command, decision 540 branches to the “no” branch where processing returns to block 535 where the systems waits for all the nodes to return the end of frame command.

On the other hand, if it is determined that all the nodes have issued the end of frame command, decision 540 branches to the “yes” branch where, at block 545, a notification is issued to the movie controller indicating an end of the frame command from all the nodes. Processing then returns to block 520 where the system waits for the next frame command from the movie controller. Processing may be interrupted if a stop command is issued by the movie controller, for example.

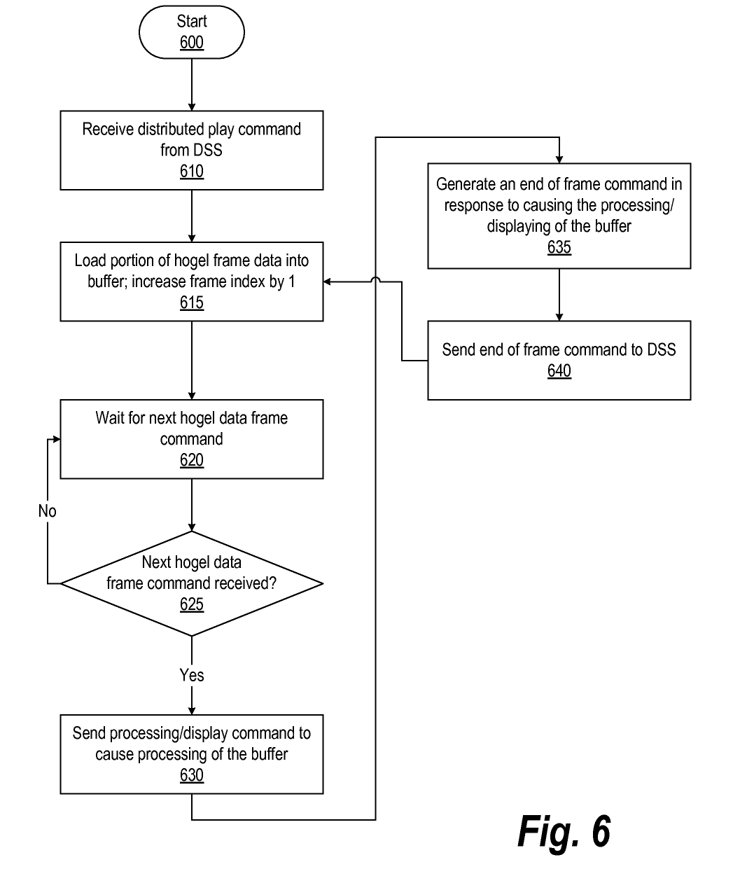

FIG. 6 is a flow diagram illustrating an alternative method for displaying prerecorded hogel data, in accordance with some embodiments. It should be noted that, in some embodiments, the methods described here may be performed by the system described in FIG. 1 though FIG. 3. In some embodiments, the methods described here may be performed by one of the multiple nodes.

Processing begins at 600 where, at block 610, a hogel data movie play command is issued by a movie controller to a distribution and synchronization service and is then distributed by the distribution and synchronization service to one or more nodes. In some embodiments, the one or more nodes may be configured to each store portions of hogel data movies. In some embodiments, the hogel data movie may be distributively stored at the one or more nodes such that a portion of each movie frame may be stored at a corresponding one of the nodes.

At block 615, a portion of a hogel data frame is loaded by each one of the nodes into a frame buffer. In some embodiments, the frame is to be processed and/or displayed by a hogel light modulator.

At block 620, each node waits for a next hogel data frame command before proceeding. At decision 625, a determination is made as to whether a next hogel data frame command has been received by each one of the nodes. If a next hogel data frame command has not yet received by a node, decision 625 branches to the “no” branch with processing returning to block 620 where the node waits for a next hogel data frame command.

On the other hand, if a next hogel data frame command is received by a node, decision 625 branches to the “yes” branch where, at block 630, the node sends a processing/display command in order to cause the processing of the frame buffer. The frame buffer and display systems may be configured to process and/or display the hogel frame in response to the commands received by each of the nodes.

At block 635, an end of frame command is generated by each node in response to each node causing the processing and/or displaying of the data in the frame buffer. At block 640, each node sends an end of frame command to the distribution and synchronization service. In some embodiments, may then issue an end of frame command to a movie controller in response to receiving an end of frame command from each of the nodes.

Processing subsequently continues at block 615 where the next portion of hogel frame data is loaded into the buffer while increasing the frame index by 1.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for processing stored hogel data, the method comprising:
causing one or more nodes to each load a subset of a hogel data set into a buffer, the one or more nodes being configured to each store the corresponding subset of the hogel data set;
distributing a next hogel data set command to the one or more nodes;
causing the buffer to be processed in response to the next hogel data set command; and
issuing a hogel data set complete command in response to determining that the one or more nodes each return a hogel data subset complete command.

2. The method of claim 1, further comprising causing the reception of another next hogel data subset command in response to the issuing of the hogel data subset complete command.

3. The method of claim 1, further comprising receiving information identifying a group of hogel data sets to be processed.

4. The method of claim 3, where the groups of hogel data sets represent movies of hogel data frames.

5. The method of claim 3, further comprising:
generating the hogel data sets; and
storing each of the subsets of the hogel data sets at the corresponding one or more nodes.

6. The method of claim 1, where causing the buffer to be processed comprises causing the buffer to be displayed on a hogel light modulator.

7. A system for processing stored hogel data, the system comprising:
one or more processors; and
one or more memory units coupled to the processor,
the system being configured to:
cause one or more nodes to each load a subset of a hogel data set into a buffer, the one or more nodes being configured to each store the corresponding subset of the hogel data set;
distribute a next hogel data set command to the one or more nodes;
cause the buffer to be processed in response to the next hogel data set command; and
issue a hogel data set complete command in response to determining that the one or more nodes each return a hogel data subset complete command.

8. The system of claim 7, where the system is further configured to cause the reception of another next hogel data subset command in response to the issuing of the hogel data subset complete command.

9. The system of claim 7, where the system is further configured to receive information identifying a group of hogel data sets to be processed.

10. The system of claim 9, where the groups of hogel data sets represent movies of hogel data frames.

11. The system of claim 9, where the system is further configured to:
generate the hogel data sets; and
store each of the subsets of the hogel data sets at the corresponding one or more nodes.

12. The system of claim 7, where the system being configured to cause the buffer to be processed comprises the system being configured to cause the buffer to be displayed on a hogel light modulator.

13. A computer program product stored on a computer operable medium, the computer program product comprising software code being effective to:
cause one or more nodes to each load a subset of a hogel data set into a buffer, the one or more nodes being configured to each store the corresponding subset of the hogel data set;
distribute a next hogel data set command to the one or more nodes;
cause the buffer to be processed in response to the next hogel data set command; and
issue a hogel data set complete command in response to determining that the one or more nodes each return a hogel data subset complete command.

14. The product of claim 13, where the software code is further effective to cause the reception of another next hogel data subset command in response to the issuing of the hogel data subset complete command.

15. The product of claim 13, where the software code is further effective to receive information identifying a group of hogel data sets to be processed.

16. The product of claim 15, where the groups of hogel data sets represent movies of hogel data frames.

17. The product of claim 15, where the software code is further effective to:
generate the hogel data sets; and
store each of the subsets of the hogel data sets at the corresponding one or more nodes.

18. The product of claim 13, where the software code being effective to cause the buffer to be processed comprises the software code being effective to cause the buffer to be displayed on a hogel light modulator.
